(19) United States
(12) Patent Application Publication
(10) Pub. No.: US 2005/0209873 A1
(43) Pub. Date: Sep. 22, 2005

(54) Pre-request title searching systems and methods

(75) Inventor: Robert F. Anastasi, Louisville, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zenodata Corporation, Louisville, CO (US)

(21) Appl. No.: 10/997,760

(22) Filed: Nov. 23, 2004

Related U.S. Application Data
(63) Continuation-in-part of application No. 10/804,472, filed on Mar. 18, 2004.

(51) Int. Cl. G06F 17/60

(52) U.S. Cl. 705/1

(57) ABSTRACT

A method of searching property records includes, for each parcel in the plurality of parcels, searching the property records to identify specific documents relating to the parcel, thus creating a results set for the parcel, organizing the results set, and saving the results set. The method also includes receiving a request from a user for a data summary relating to a specific parcel. The specific parcel has a results set associated therewith. The method further includes using the results set to prepare the data summary and sending the data summary to the requestor. Searching the property records is performed prior to receiving a request from any requester.

### CROSS-REFERENCES TO RELATED APPLICATIONS

This application is a continuation-in-part of, and claims the benefit of, co-pending, commonly-assigned U.S. patent application Ser. No. 10/804,472, entitled “AUTOMATED RECORD SEARCHING AND OUTPUT GENERATION RELATED THERETO” (Attorney Docket No. 040143-000200), filed on Mar. 18, 2004, the entirety of which is herein incorporated by reference for all purposes.

This application is related to the following co-pending, commonly-assigned U.S. Patent Applications, the entirety of each of which are herein incorporated by reference for all purposes: Provisional U.S. Patent Application No. 60/554,511, entitled “PROPERTY RECORDS DATABASES AND SYSTEMS AND METHODS FOR BUILDING AND MAINTAINING THEM” (Attorney Docket No. 040143-000100), filed on Mar. 18, 2004; U.S. patent application Ser. No. 10/804,468, entitled “DOCUMENT SEARCH METHODS AND SYSTEMS” (Attorney Docket No. 040143-000300), filed on Mar. 18, 2004; U.S. patent application Ser. No. 10/804,467, entitled “DOCUMENT ORGANIZATION AND FORMATTING FOR DISPLAY” (Attorney Docket No. 040143-000400), filed on Mar. 18, 2004; Provisional U.S. Patent Application No. 60/554,514, entitled “CONFIDENCE-BASED NATURAL LANGUAGE PARSING” (Attorney Docket No. 040143-000500), filed on Mar. 18, 2004; Provisional U.S. Patent Application No. 60/554,513, entitled “CONTEXTUAL CONVERSION OF LANGUAGE TO DATA” (Attorney Docket No. 040143-000600) filed on Mar. 18, 2004; U.S. patent application Ser. No. 10/876,250, entitled “EVALUATING THE RELEVANCE OF DOCUMENTS AND SYSTEMS AND METHODS THEREFOR” (Attorney Docket No. 040143-000700), filed on Jun. 23, 2004; U.S. patent application Ser. No. 10/966,155, entitled “TITLE QUALITY SCORING SYSTEMS AND METHODS” (Attorney Docket No. 040143-000800), filed on Oct. 14, 2004; and U.S. patent application Ser. No. 10/966,154, entitled “TITLE EXAMINATION SYSTEMS AND METHODS” (Attorney Docket No. 040143-000900), filed on Oct. 14, 2004.

### BACKGROUND OF THE INVENTION

The present invention relates generally to search systems. More specifically, the present invention relates to systems and methods for performing property records searches.

The practice of recording real property interests and transfers thereof is well known. Local governments (e.g., counties) typically administer the recording system. Most any time a property owner transfers an interest in his property, a document evidencing the transfer is recorded in the county where the property is located, thus providing notice to others of who owns what interest in the property. The property owner may transfer all his right, for example, when an individual sells his primary residence, in which case a deed usually is recorded. In another example, a property owner may transfer only a right to foreclose on a mortgage if he does not make required payments, in which case a mortgage may be recorded. Those skilled in the art will appreciate other examples.

Before an entity (grantee) gives value in return for an interest in property, that entity typically desires to confirm that the property owner (grantor) has the right to transfer the interest. It is common practice for title companies to provide this insurance in the form of “title policies.” Essentially an “owner's title policy” is an insurance policy that insures the grantee against the risk of receiving a defective interest in property. Before issuing a title policy, a title company physically searches recorded property records to create a chain of title and identify potential encumbrances to effective transfer of any of the bundle of rights associated with the subject property. Likewise, before a lender lends money secured by property, the lender typically searches the property records to assess the quality of the collateral. Such lenders purchase a “loan title policy” to insure the lender against the risks of making a loan on a property with potential title problems. These are, of course, but two examples of instances in which searching property records is desirable, albeit probably the most common examples.

For a number of reasons, the process of searching property records is labor intensive. Property records typically are recorded in chronological order, not according to location, thus complicating the task of identifying recorded documents relating to a specific parcel from among the thousands of recorded documents. Further, any given parcel is a subdivided portion of a larger parcel and the property description is not consistent. Further still, a variety of documents are used to record transfers of property interests, and a standard format does not exist. Errors in recorded documents or in the indexing system used to locate the records further compound the problem. Current name indexing systems are based on exact matches or problematic soundex search techniques, which either miss records or return erroneous and not-applicable records. Probably most importantly, however, is the lack of an electronic data extraction and searching system that includes all the information an underwriter may need to know about a parcel before issuing a policy or approving a loan relating to the property.

There also exists a need for systems and methods for evaluating an entity's interest in property—i.e., the quality of the entity's title. Any number of events and circumstances may affect a property interest or the value of the property in which the interest is held. Partial transfers, transfers by fewer than all owners, liens, judgments, foreclosures, probate or estate issues, bankruptcies, mortgages, acts of law, civil actions, and the like are merely a few examples of these events and circumstances, many or all of which could be synthesized and summarized in a meaningful way if the data were available.

Thus, embodiments of the present invention relate to systems and methods for improving the efficiency of property record searches, as well as analyzing and summarizing the results thereof.

### BRIEF SUMMARY OF THE INVENTION

Embodiments of the invention thus provide a property searching method. The method includes receiving property records relating to a plurality of parcels at a host computer system, storing the records in a searchable database and for each of the plurality of parcels, searching the property records to identify property records relating to the parcel, thereby producing a results set for each parcel. The results set for each parcel includes the property records relating to that parcel. The method also includes saving the results set for each of the plurality of parcels and receiving additional property records at the host computer system. The additional property records relate to only selected ones of the plurality of parcels. The method also includes updating the results set for each of the selected ones of the plurality of parcels, thereby creating an updated results set for each of the selected ones of the plurality of parcels. The method further includes saving the updated results sets and, at the host computer system, receiving a request from a user for a data summary relating to a specific parcel. The specific parcel is one of the selected ones of the plurality of parcels. The method also includes using the updated results set for the specific parcel to prepare the data summary and sending the data summary to the user.

Other embodiments provide a method of searching property records relating to a plurality of parcels. The method includes, for each parcel in the plurality of parcels, searching the property records to identify specific documents relating to the parcel, thus creating a results set for the parcel, organizing the results set, and saving the results set. The method also includes receiving a request from a user for a data summary relating to a specific parcel. The specific parcel has a results set associated therewith. The method further includes using the results set to prepare the data summary and sending the data summary to the requestor. Searching the property records is performed prior to receiving a request from any requester.

In some embodiment, each results set includes information from which an underwriter can underwrite a title policy, using commonly-accepted title policy underwriting rules, without reference to source documents, or images thereof, from which the results set originated. The method may include receiving property record data for a plurality of parcels into a computer system. The property record data may relate to source property record documents. The method also may include storing the property record data in a searchable database as the property records. The data summary may include a purchase title policy, refinance title policy, prelim, title information report, abstract, purchase title commitment, refinance title commitment, document, data stream, electronic transmission, and/or the like. The results set may include a purchase title policy, refinance title policy, prelim, title information report, abstract, purchase title commitment, refinance title commitment, title score, and/or the like. The property records may include physical documents. The property records may include electronic documents.

Other embodiments provide a method of searching property records relating to a plurality of parcels. The method includes receiving a plurality of property records at a host computer system, storing the property records in a searchable database, for each of the plurality of parcels, and searching the database to identify property records relating to the parcel, thereby producing a results set for each parcel. The results set for each parcel includes the property records relating to that parcel. The method also includes saving the results set for each of the plurality of parcels and, for each of the plurality of results sets, identifying relationships among the property records in the results set, using the property records and relationships to identify anomalies, correcting the anomalies, and updating the results set, thereby creating an updated results set for each parcel having an anomaly. The method also includes saving the updated results set, and, at the host computer system, receiving a request from a user for a data summary relating to a specific parcel. The specific parcel has an updated results set associated with it. The method also includes using the updated results set for the specific parcel to prepare the data summary and sending the data summary to the user.

Still other embodiments provide a method of searching property records relating to a plurality of parcels. The method includes receiving a plurality of property records at a host computer system, storing the property records in a searchable database, and, for each of the plurality of parcels, searching the database to identify property records relating to the parcel, thereby producing a results set for each parcel. The results set for each parcel includes the property records relating to that parcel. The method also includes saving the results set for each of the plurality of parcels and, for each of the plurality of results sets, identifying relationships among the property records in the results set. The method further includes using the relationships and results sets to generate a report, using the report to revise the database, at the host computer system, receiving a request from a user for a data summary relating to a specific parcel, using the revised database to prepare the data summary, and sending the data summary to the user.

The plurality of records may include a first plurality of records related to a first geographic region and using the report to revise the database may include selecting records from a second plurality of records relating to a second geographic region to include in the searchable database. The first and second geographic regions may be the same region. The first and second geographic regions may be different regions. The report may include information relating to the number of parcels in the plurality of parcels having a good stop subsequent to a particular date.

Other embodiment provide a property records search system. The system includes a host computer system, a searchable database, and software that programs the host computer system. The software programs the host computer system to receive property records relating to a plurality of parcels, store the property records in a searchable database, and, for each of the plurality of parcels, search the property records to identify property records relating to the parcel, thereby producing a results set for each parcel. The results set for each parcel includes the property records relating to that parcel. The software also programs the host computer system to save the results set for each of the plurality of parcels and receive a request from a user for a data summary relating to a specific parcel. The specific parcel has a results set associated therewith. The software also programs the host computer system to use the results set to prepare the data summary and send the data summary to the requester.

The data summary may include a purchase title policy, refinance title policy, prelim, title information report, abstract, purchase title commitment, refinance title commitment, document, data stream, electronic transmission, and/or the like. The results set may include a purchase title policy, refinance title policy, prelim, title information report, abstract, purchase title commitment, refinance title commitment, title score, and/or the like. The software also may program the host computer system to, for each of the plurality of results sets, identify relationships among the property records in the results set, use the relationships and results sets to generate a report, use the report to revise the database, and use the revised database to prepare the data summary. The records may be a first plurality of records related to a first geographic region and, in programming the host computer system to use the report to revise the database, the software programs the host computer system to select records from a second plurality of records relating to a second geographic region to include in the searchable database. The first and second geographic regions may be the same region. The first and second geographic regions may be different regions. The report may include information relating to the number of parcels in the plurality of parcels having a good stop subsequent to a particular date. The software also may program the host computer system to, for each of the plurality of results sets, identify relationships among the property records in the results set, use the property records and relationships to identify anomalies, correct the anomalies, and update the results set, thereby creating an updated results set for each parcel having an anomaly, save the updated results set, and use an updated results set to prepare the data summary. The software also may program the host computer system to receive additional property records at the host computer system. The additional property records may relate to only selected ones of the plurality of parcels. The software also may program the host computer system to update the results set for each of the selected ones of the plurality of parcels, thereby creating an updated results set for each of the selected ones of the plurality of parcels, save the updated results sets, and use an updated results set to prepare the data summary.

Other embodiments provide computer-readable media having stored thereon computer-executable instructions for performing a method. The method includes receiving property records relating to a plurality of parcels, storing the property records in a searchable database, and, for each of the plurality of parcels, searching the property records to identify property records relating to the parcel, thereby producing a results set for each parcel. The results set for each parcel includes the property records relating to that parcel. The method also includes saving the results set for each of the plurality of parcels and receiving a request from a user for a data summary relating to a specific parcel. The specific parcel has a results set associated therewith. The method also includes using the results set to prepare the data summary and sending the data summary to the requestor.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a title searching system according to embodiments of the system.

FIG. 2 illustrates a title searching method according to embodiments of the invention.

FIGS. 3A and 3B illustrate exemplary source property record documents.

FIG. 4 illustrates a method of converting property records to data according to embodiments of the invention.

FIGS. 5A-5F illustrate exemplary output documents according to embodiments of the invention.

FIGS. 6A-6F illustrate exemplary display screens for interacting with the system according to embodiments of the invention.

### DETAILED DESCRIPTION OF THE INVENTION

Embodiments of the present invention provide systems and methods for automating the process of property records searching. In some embodiments, the present invention produces a data summary in response to a query that identifies a parcel, a grantor, and/or a specific document associated with the parcel. In some embodiments, the data summary is a title abstract. A title abstract according to some embodiments has sufficient information to allow a title policy underwriter (title examiner, examiner, underwriter, or abstracter) to provide a title commitment using commonly-accepted title policy underwriting rules. Thus, the systems and methods disclosed herein can produce or be used to produce a title commitment and/or title policy without reference to the source property record documents. In some embodiments, the data summary has sufficient information to assess the quality of the title of a parcel that is being used to secure a loan, using commonly-accepted loan underwriting rules, without reference to the source property record documents.

While embodiments of the invention disclosed herein are described in relation to searching property records associated with real property, this is not a requirement. The systems and methods described herein may be applied to records searches relating to personal property, professional licenses, corporate filings, and the like. Those skilled in the art will recognize many other examples in light of the disclosure herein. Further, while the specific examples used herein refer to title policies, title abstracts, title commitments, and other title and real estate industry-related product outputs, these examples are not intended to limit the scope of the invention. As previously mentioned, embodiments of the invention may be used by loan underwriters to assess the quality of the collateral (i.e., title for the parcel) and approve a loan, using commonly-accepted loan underwriting rules, without reference to the source property record documents. Embodiments of the invention may produce or be used to produce other types of output, including standard templates or forms and derivates of these templates or forms: American Land Title Association (ALTA) Loan Policy; ALTA Owner's Policy; ALTA Short Form Residential Loan Policy; Homeowner's Policy of Title Insurance for a One-to-Four Family Residence; Standard Exceptions to the ALTA Loan Policy; endorsements to ALTA policies; a Title Information Report (TIR) or “Prelim”; a title commitment for policies such as the foregoing; a Full Abstract—Refinance; a Full Abstract—Purchase; an “O&E”; and the like.

In some embodiments, the searching process is enabled by the collection of a comprehensive set of property record data covering a specified period of time for a given geographic area. The data set is then stored in a searchable database. For example, in a specific embodiment, data from all property records in a particular county for the past ten years is reduced to electronic form. In another embodiment, the period includes all records going back to the time of the original land grant. In other embodiments, the time period may be longer or shorter than these examples and may be determined based on local practice, underwriting requirements, the statute of limitations relating to correcting defective property transfers in the subject region, or the like. Other examples exist.

While the geographic region typically is a county, other larger or smaller regions may be used. For example, some embodiments may operate only on a subdivision or planned urban development (PUD), while others operate on an entire state or region of the country. The region typically is determined to be the region covered by the recording entity.

The records may come from a county courthouse, state courthouse, federal court records, bankruptcy records, tax and assessor records, Geographic Information System (GIS) records, and the like. The records from which the data set is collected may include deeds, mortgages, UCC filings, liens, releases of liens, releases of mortgages, judgments, lis pendens, federal tax liens, state tax liens, maps, plats, and the like. The items of data collected include: property address, legal description, grantor name, grantee name, document date, recordation data, reception number, document type, other items to be identified hereinafter, and the like.

Embodiments of the present invention do not merely collect electronic images of recorded documents. Further, embodiments of the invention do not merely digitize data (e.g., grantor, property address, legal description, and the like) to create electronic indexes used to locate source documents. Embodiments of this invention reduce a comprehensive set of property records to a form that may be entered into a searchable database and used to complete the searching process, not merely locate source documents or electronic images thereof that then must be examined. The systems and methods described herein produce output (e.g., a paper document, an image on a computer screen, an electronic data file) that contains sufficient information to underwrite any of many different types of title commitments or title policies, as referenced earlier herein, or the like, without reference to the source documents. Of course, the systems and methods described herein may be used for other purposes, such as, for example, legal disputes, real estate research and due diligence, constructing an offer to buy, fraud detection, loan portfolio risk management, easement identification, data mining, marketing, or merely to satisfy some curiosity relating to the ownership history of a parcel. Many other examples are possible.

The data to be included in the set may be determined by commonly-accepted rules for the particular task. These may include: local title policy underwriting rules, federal loan underwriting rules, state insurance rules, local loan underwriting rules, customer-specific rules, and the like. As an example, if commonly-accepted title policy underwriting rules base an underwriting decision on whether a particular parcel abuts a body of water, then the data set will include a field for waterfront property information. In some examples, this may be merely a binary field having one value for waterfront property and another for non-waterfront property. In other examples, however, additional fields may be included that indicate the type of body of water, the portion of a parcel that abuts the water, and the like. Many other such examples are possible.

In some embodiments, the data is document-centric, although other examples are possible (e.g., person-centric; parcel-centric). In document-centric embodiments, even though the information is stored in searchable form, for example in a relational database, the data is organized, at least initially, according to documents. The documents correspond to specific recorded property records having potentially-relevant property data. Thus, in these embodiments, the automated searching process resembles the process a searcher might perform manually: the process identifies documents having data related to a property and evaluates the data to determine if the document is relevant to issuing a policy on the property. Irrelevant documents are ignored, and the data on relevant documents are summarized in an abstract from which an underwriter may generate a commitment.

In some embodiments, the abstract (or other output) may include a list of documents and a relevance score for each document. The score may be generated using any of a number of scoring algorithms. For example, the score may be based on a number of comparisons between the document being scored and a source document or group of documents. The more closely the data on the document match that on other documents or the data used to initiate the search, the higher the score and vice versa. The score may be based, at least in part, on the number of ways a document is located (e.g., name search, grantor search, address search, legal description search, and the like). The more searches that return a document, the more likely the document is to be relevant and the higher the score. The score may be weighted to favor data elements of greater significance. Many such examples are possible.

In some embodiments, the output may include a score, a grade, or a list of exceptions that summarizes the data gathering process in a meaningful way in a manner similar to the way credit reporting agencies score credit reports. The score could be based on specific customer requirements or could be industry standard scores.

As mentioned previously, the output may assume any of a number of forms. The output may be electronic or paper, for example. Paper output may be an abstract, portions of an abstract, a policy, a chain of title, a commitment, a document list, and the like. In addition to these, electronic output may include hyperlinks that allow a user to obtain more detailed information about an item or navigate among different portions of the output. For example, although not needed to underwrite a policy, an underwriter may desire to view an image of a relevant document. A hyperlink in a listing of documents may be used to return the image. Many other examples are possible.

In some embodiments, the output includes an electronic file having data that may be used for any of a number of purposes. The file, which may be transmitted as a data stream over a network between computing devices, may be an ASCII text file, a comma-delimited file, or the like. The file may be in EDI, EDIFACT, ANSI X12, or other suitable format. The file may include XML elements or tags, XML attributes, DTDs, LDDs XML schemas, and the like. Many other examples are possible and apparent to those skilled in the art in light of this disclosure. The information transmitted in the electronic file may be used, for example, to populate fields in documents such as policies, mortgages, deeds, and the like.

In some embodiments, property records are searched, either electronically or physically, to create results sets prior to receiving a request from a user for a data summary. The results sets may be periodically updated, for example when new property records are added. The results sets may be used for any of a number of purposes as will be described immediately hereinafter. The results set may include a compete product, such as an abstract, title commitment, title policy, score, and/or any of the aforementioned products.

In some embodiments, the results sets are used to identify and possibly correct anomalies. Anomalies may be data entry errors, discontinuities in a chain of title, misposted documents, ineffective title transfers, incomplete title transfers, overlapping ownership interests, satisfactions with no corresponding mortgage or deed of trust, release with no corresponding lien, and/or the like.

In some embodiments, the results sets are used to quickly respond to user requests. Property records searches can be resource intensive with respect to both human and electronic resources. Creating results sets during times of low resource utilization reduces the time necessary to respond to user requests. Responding more quickly to user requests improves the utility of embodiments of the invention.

In some embodiments, the results sets are used to produce reports. The reports may include a variety of items of information and may be used to improve the efficiency of the system, among other things. In a specific embodiment, the report identifies the number of parcels in a specific geographic area that have a good stop subsequent to a specific date. This information may be used to determine how far back in time an effective property records system should go. For example, if eighty percent of the parcels in a given geographic region have a good stop in their chains of title within the past fifteen years, then fifteen years of property records may be sufficient for a property records search system for that region. Of course, different percentages and ranges could be used for the report. As another example, the number of documents a search identifies and the time a search takes may be used for future pricing decisions and system configurations. Those skilled in the art will realize many other examples in light of this disclosure.

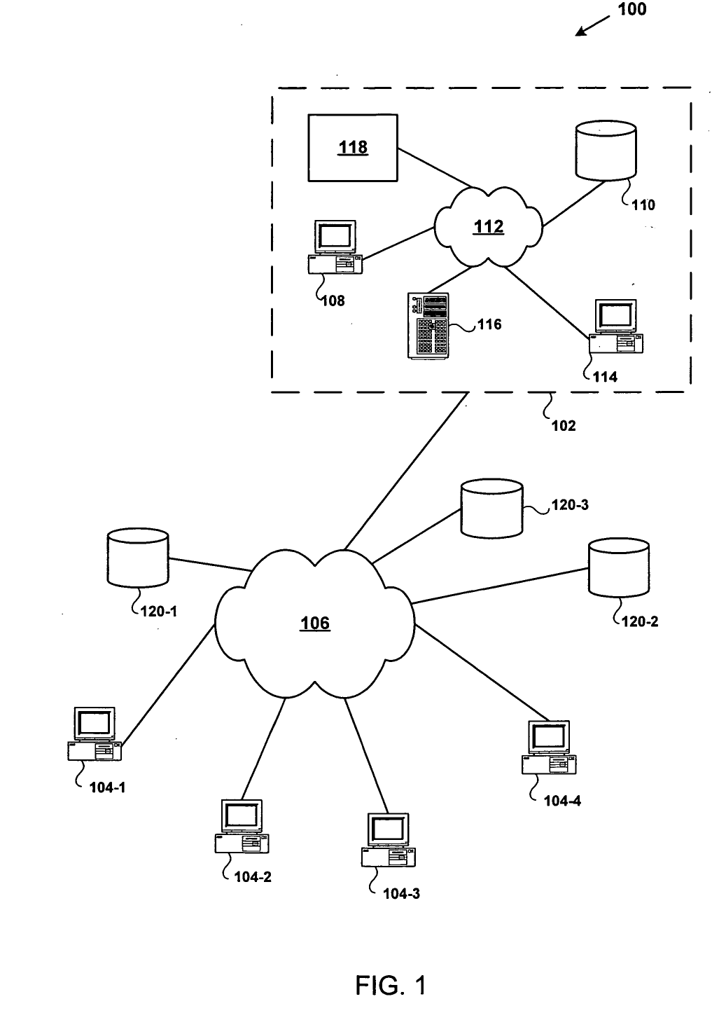

Having described embodiments of the invention generally, attention is directed to FIG. 1, which illustrates an example of a property records searching and examination system 100 according to more specific embodiments of the invention. The system 100 includes a host computer system 102. The host computer system 102 may include any of a number of computing devices, peripheral devices, network devices, input devices, output devices, and the like. All the devices that comprise the host computer system 102 may be co-located at a single facility or distributed geographically. Further, the host computer system need not be commonly owned or controlled. For example, examination and/or scoring functions may be performed at one location by a first entity, while search and organization functions are performed at a different location by a second entity. In a specific embodiment, the host computer system 102 is a single computing device that users 104 may access via a network 106. Many other examples are possible.

In a specific embodiment, the host computer system 102 includes a workstation 108, a data storage arrangement 110, and an internal network 112 that allow the two to communicate. The workstation 108 may be any computing device or combination of computing devices capable of performing the processes described herein. The workstation 108 includes a processor and software that programs the processor to operate according to the teachings herein. As is known in the art, the software may be stored on computer-readable media in the form of computer-executable instructions. In some embodiments, the software may reside on the storage arrangement 110. The storage arrangement 110 may be, for example, any magnetic, electronic, or optical storage system, or any combination of these. The storage arrangement may be a server, or combination of servers having RAM, ROM, hard disk drives, optical drives, magnetic tape systems, and the like or any combination. In some embodiments, each geographic region is represented by a server or group of servers. Many other examples are possible. The internal network 112 may be any of a number of well known wired or wireless networks or combinations thereof. For example, the internal network may be a LAN, WAN, intranet, the Internet, or the like. Many other examples are possible. The host computer system also may include administrative computers 114 (e.g., personal computers, laptop computers, and the like) that may be used to assist in the operation of the system. The host computer system 102 also may include network interfaces 116 (e.g., web server) that enable communication between the host computer system 102 and users 104.

The host computer system 102 also may include an input workflow process and system 118 (“input system 118” hereinafter). In its most basic form, the input system 118 receives source property records, converts the property records to searchable data, and delivers the data to the storage arrangement. This process will be described in greater detail hereinafter. The input system 118 need not be a single device, nor located at a single location.

The network 106 may be any wired or wireless network, or any combination thereof. In a specific embodiment, the network 106 is the Internet. The users 104 may be any computing device capable of providing a user access to the host computer system 102. In a specific embodiment, the user 104-1 is a desktop computer of an underwriter, an abstracter, an underwriter's agent, an examiner, or the like, through which the host computer system is accessed, via the Internet, for purposes of performing a search and underwriting a policy or loan for a customer.

The system 100 also may include one or more external databases 120. The external databases may be public record databases, land records databases, industry record databases, “starter file” databases (e.g., a database of previously-issued title insurance commitments, title policies, or the like), insurance claim databases, and the like. For example, the external database 120-1 may be a civil court record database for a specific county or other geographic region. This database may store information on civil proceedings such as marriages, divorces, bankruptcies, and the like. The database 120-2 may be, for example, an insurance database that stores information relating to insurance claims homeowners file. The database 120-3 may be a tax assessor's database that stores information relating to property valuations. Many other examples are possible.

Those skilled in the art will appreciate that the foregoing is but one example of a system according to embodiments of the invention. Many other examples are possible.

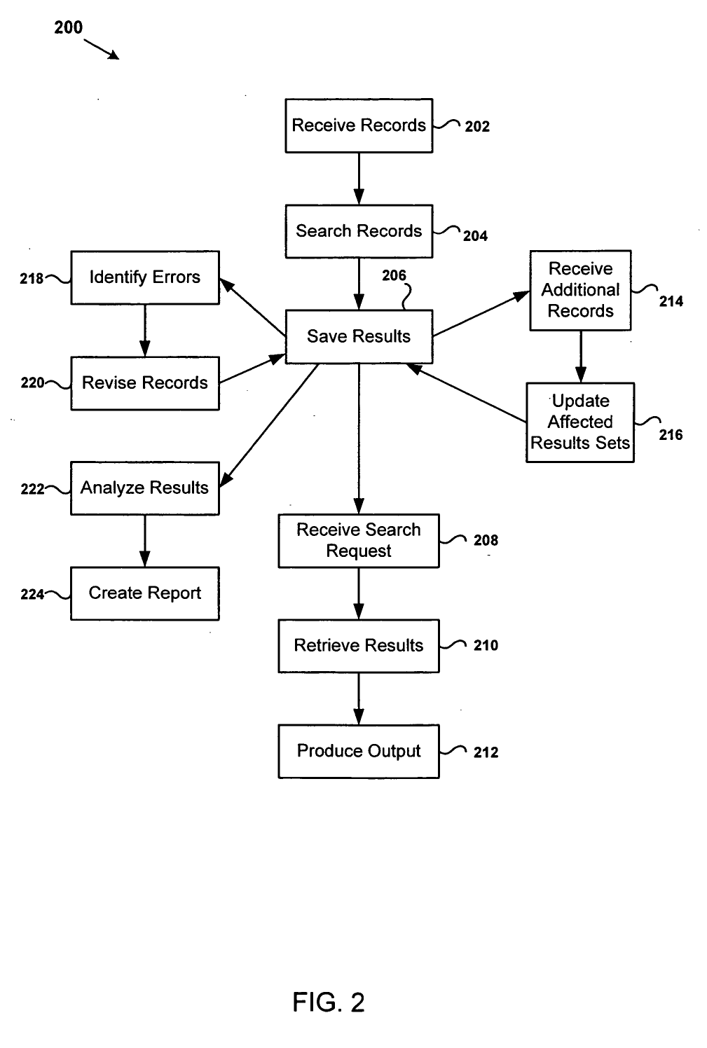

Having described an exemplary system according to embodiments of the invention, attention is directed to FIG. 2, which illustrates an exemplary method 200 according to embodiments of the invention. The method may be implemented in the system 100 described above or in another suitable system. Those skilled in the art will appreciate that alternative methods according to embodiments of the invention may include more or fewer steps and that the steps described herein may be performed in different orders than that described with respect to this exemplary embodiment.

The method 200 begins with the receipt of property records at block 202. The records may be received in any of a number of forms. For example, in some embodiments, the property records are received as paper copies of all documents recorded in a given jurisdiction. In other embodiments, the property records are received as a collection of image files. The image files may be stored in magnetic (e.g., on one or more computer disks) or optical (e.g., on one or more CDs) form, or the like, or a combination of such. The image files may include microfilm or microfiche images. Many other examples are possible.

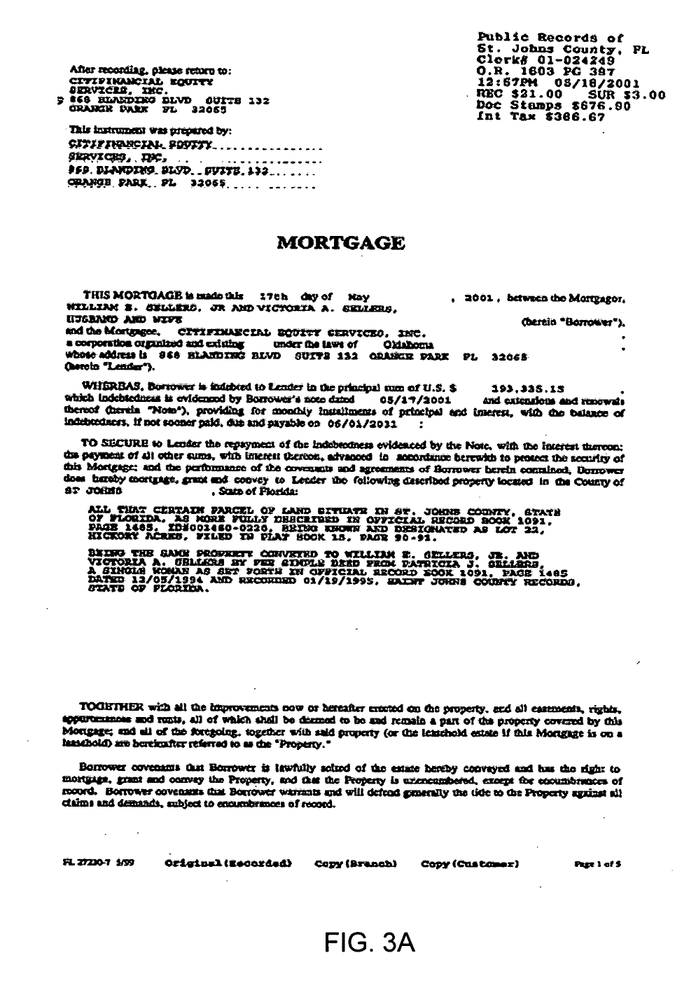

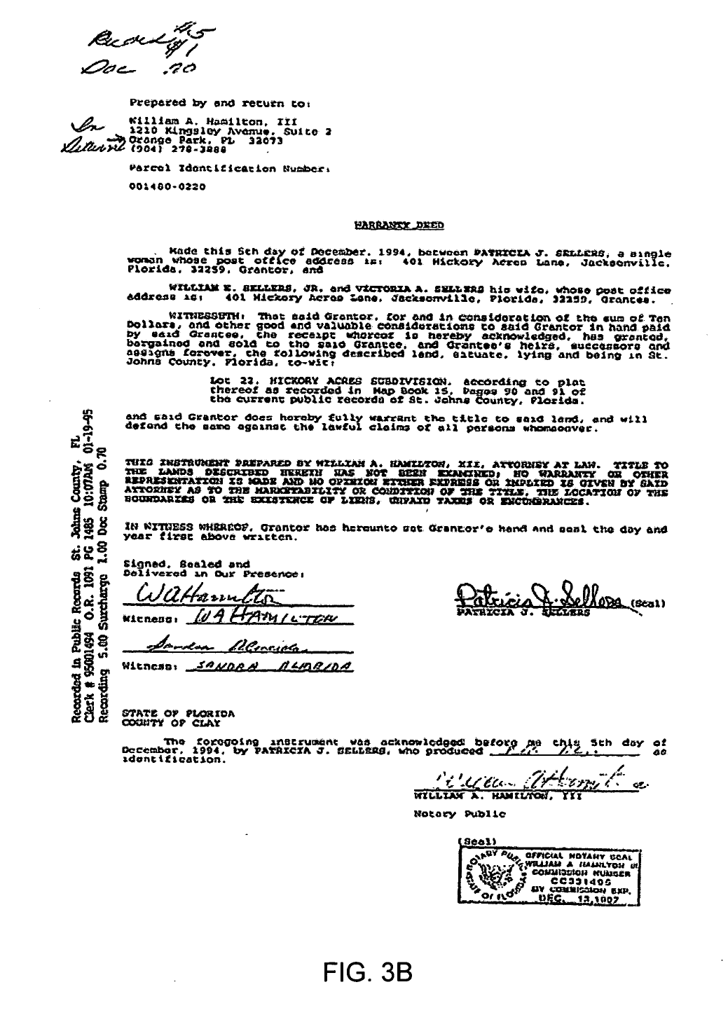

As mentioned previously, the property records may include deeds, mortgages, liens, releases, and the like. FIGS. 3A and 3B illustrate examples of the types of property records that serve as source documents according to embodiments of the invention and the data that are gathered there from. For example, FIG. 3A illustrates a mortgage. The mortgage includes a mortgagor name, a mortgagee name, a transaction date, a legal description, a recordation date, and the like. FIG. 3B illustrates a warranty deed. The deed includes grantor, grantee, legal description, and the like. Those skilled in the art will appreciate many other examples of recorded documents and the data contained thereon.

Also at block 202, the property records are converted to data and loaded into a database such as the storage arrangement 110 of FIG. 1. This may involve the use of the input system 118 of FIG. 1. This process is described in greater detail hereinafter and in previously incorporated provisional U.S. Patent Application No. 60/554,511, (Attorney Docket No. 040143-000100). Briefly, however, this comprises extracting from the property records all data needed to underwrite a policy, loan or the like according to commonly-accepted underwriting rules.

Once extracted, the data are loaded into a database, for example a searchable relational database, and stored for future use. The data may be stored such that all data from a specific record, parcel, person, or the like, is logically grouped together. This preserves the data as a document, yet allows the data to be searched in many different ways.

At block 204, pre-search results sets are created. Pre-request results set (or simply “results sets”) may be created for every parcel in a geographic region or only for selected parcels and may be used for any of a number of useful purposes, as will be explained in more detail hereinafter. In a specific embodiment, the results set for a specific parcel includes items similar to or identical to that which would be produced in response to a search request. for example, items such as title commitments, title policies, scores, and/or the like, may be included in a results set. Title scores may be determined as described more fully in previously-incorporated U.S. patent application Ser. No. 10/966,155, entitled “TITLE QUALITY SCORING SYSTEMS AND METHODS.” Creating pre-search results sets may include locating potentially relevant documents as described more fully in previously-incorporated U.S. patent application Ser. No. 10/804,468, entitled “DOCUMENT SEARCH METHODS AND SYSTEMS.” This comprises using the property records to identify documents potentially related to the parcel. As documents are located, additional searches may be performed using data from these documents. Thus, a document may be identified as potentially relevant based on more than one data element. This helps to lessen the possibility that a relevant document will not be located due to typographical errors or other mistakes present on the recorded document.

Creating the results set also may include organizing potentially-relevant documents as more fully described in previously-incorporated U.S. patent application Ser. No. 10/804,467, entitled “DOCUMENT ORGANIZATION AND FORMATTING FOR DISPLAY” (Attorney Docket No. 040143-000400). This may include matching mortgages with mortgage releases, matching liens with lien releases, constructing a chain of title, locating a good stop for a chain of title, matching multiple grantees in a transfer to grantors in a subsequent transfer, and the like. Those skilled in the art will appreciate other items that may be included in results sets in light of this disclosure.

Creating results sets may include using the property records to identify parcels within a geographic region and using an identifier for each parcel to search the property records and organize the documents as if a customer had initiated the request. In addition to parcel identifiers, results sets may be created using other identifiers, such as names or legal descriptions. Many other examples are possible.

At block 206, the pre-search results sets are saved for future use. The results sets may be saved using any identifier that would allow the results set to be recalled for future use in response to a user request. For example, results sets may be stored by address, legal description, grantor name, grantee name, and/or the like. Many examples are possible.

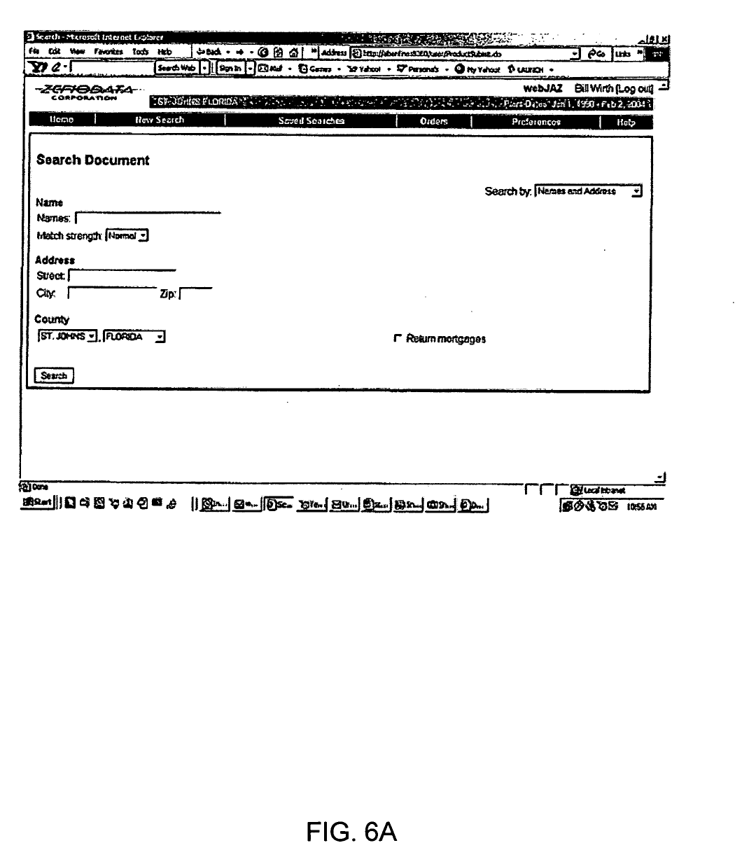

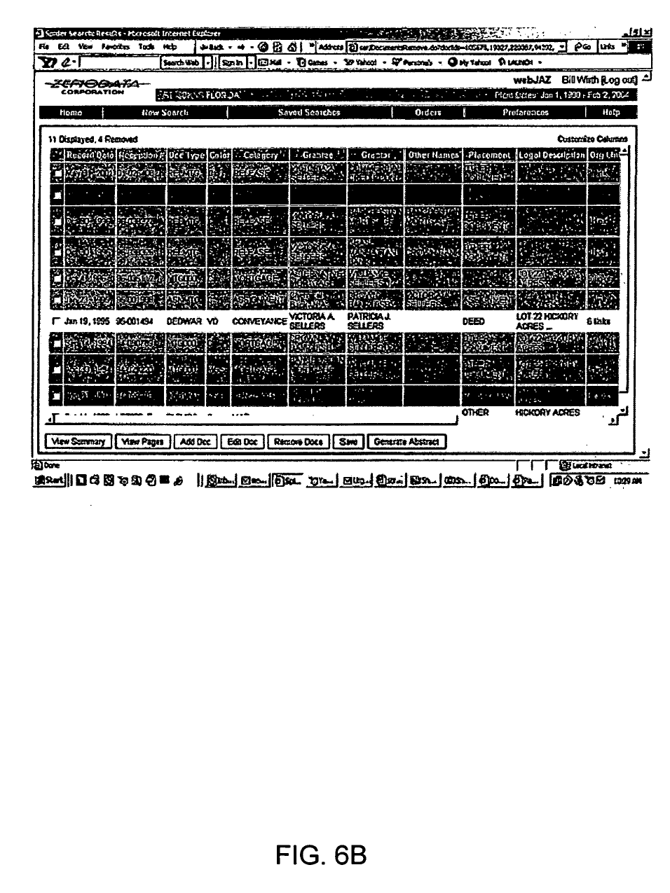

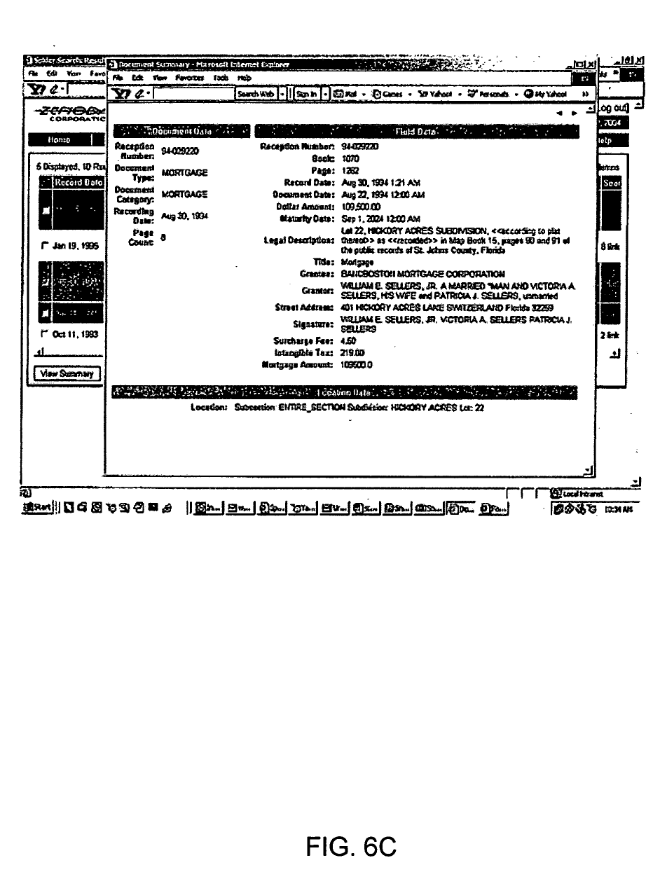

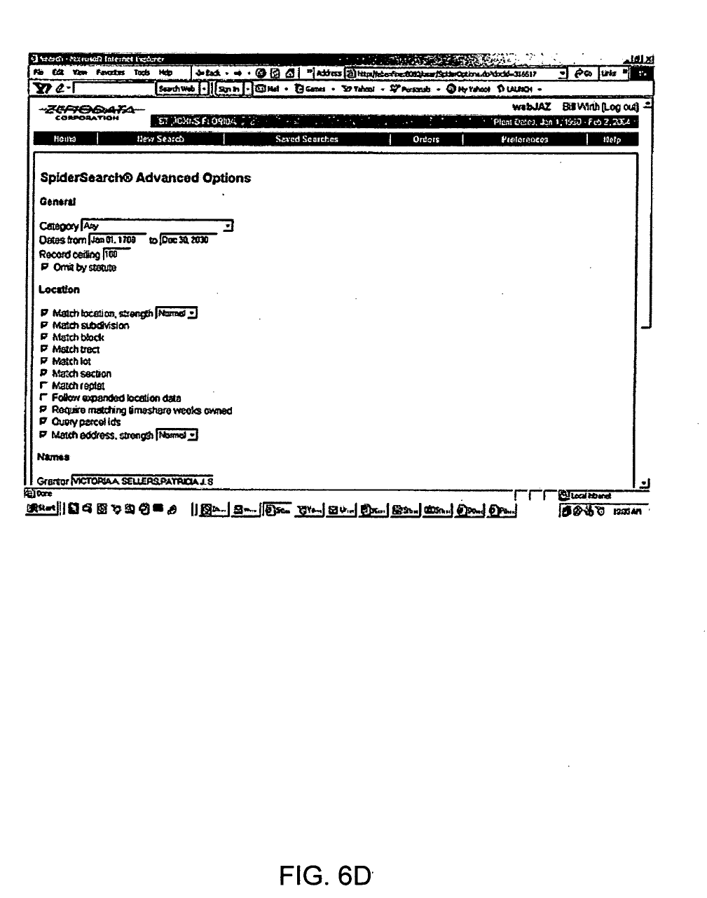

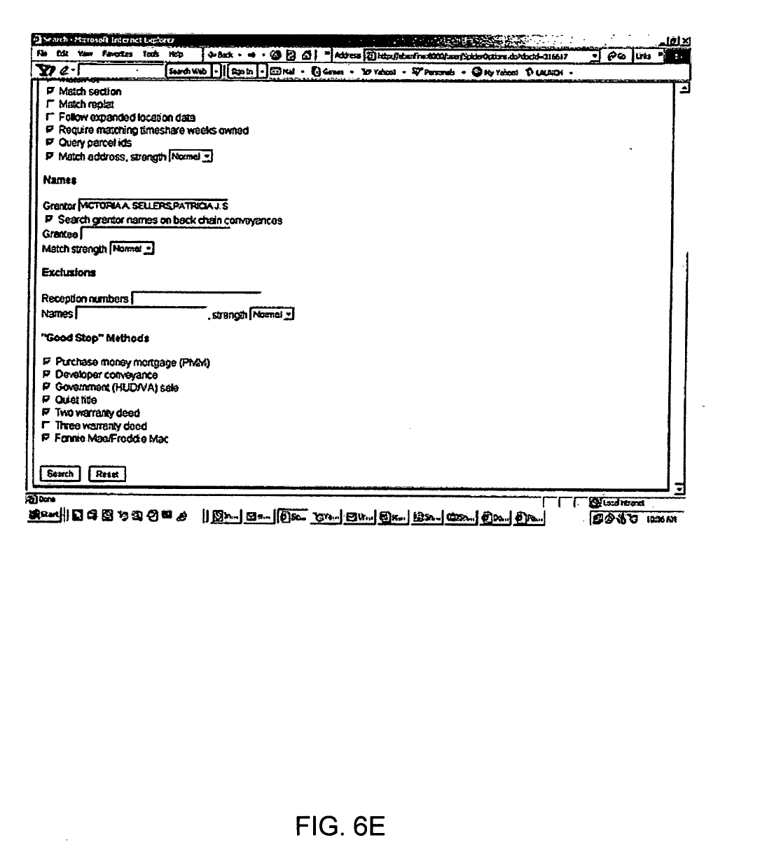

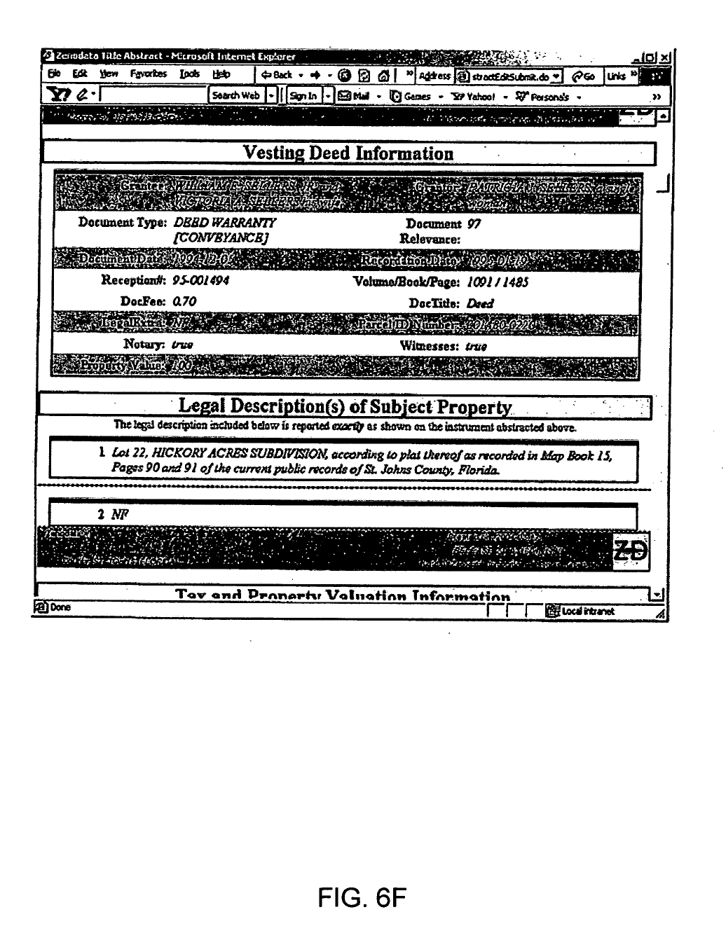

At block 208, a search request is received. In a specific embodiment, this comprises receiving a request via a network (e.g., the Internet, or other network represented by the network 106 of FIG. 1) from a user, such as one of the users 104 of FIG. 1. The request may comprise one or more data elements on which the user would like to base the search. Exemplary data elements include the property address, a legal description of the property, the grantor in a property transaction, and the like. In some embodiments, the user may supply a specific document (e.g., by providing the reception number of the recorded document) on which the user desires the search to be performed. The user may use display screens such as those described hereinafter with respect to FIGS. 6A-6F. The request also may include a request for specific output. For example, the user may want a document list, an abstract, a policy, a title marketability score or grade, and/or the like.

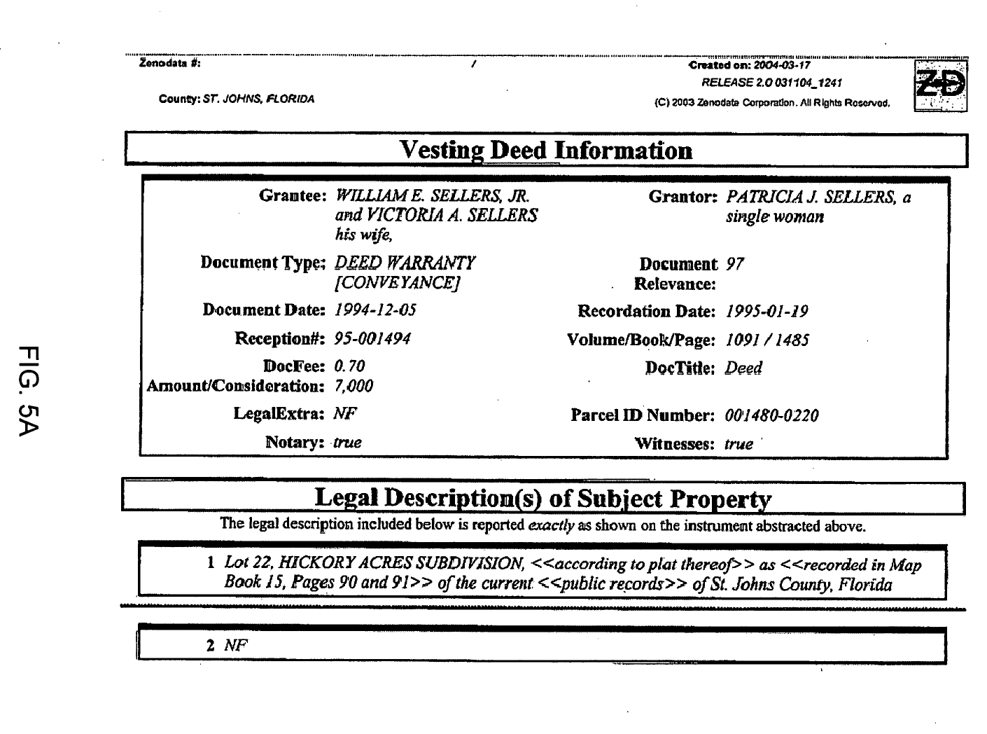

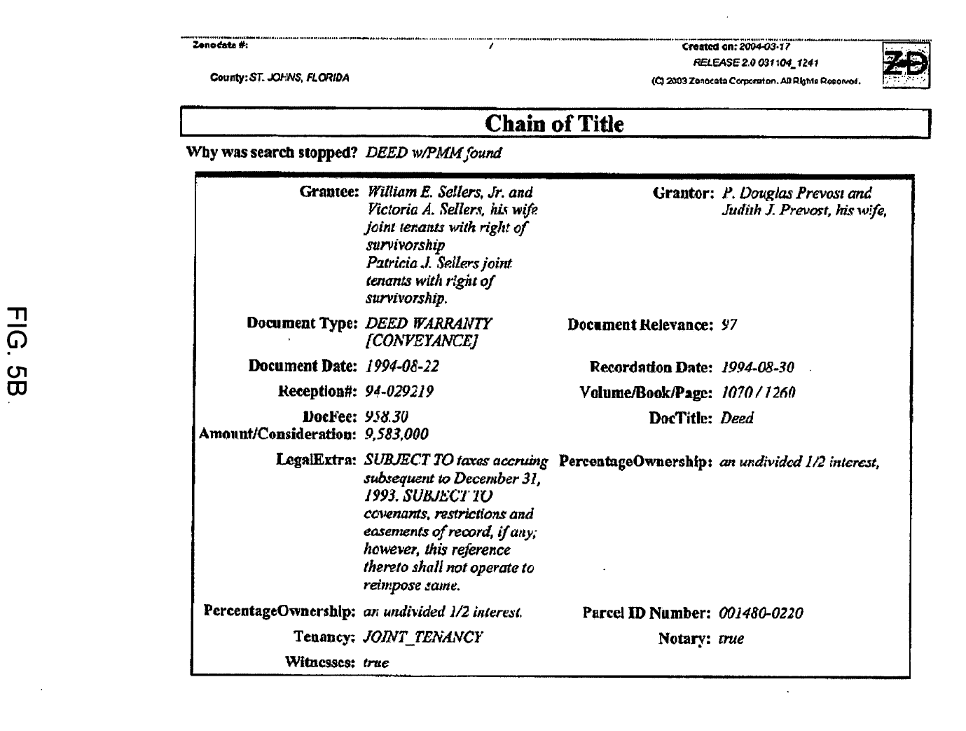

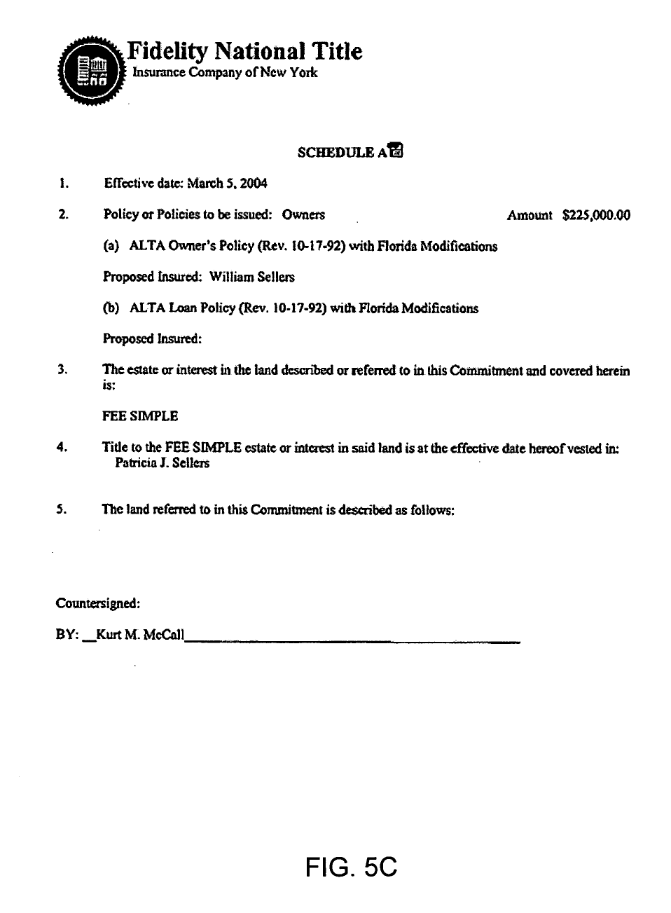

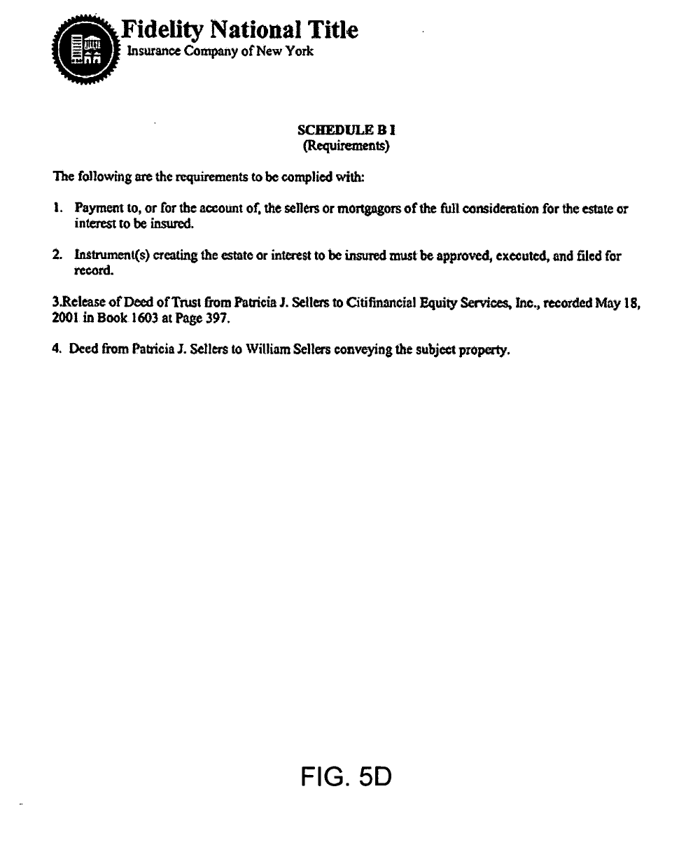

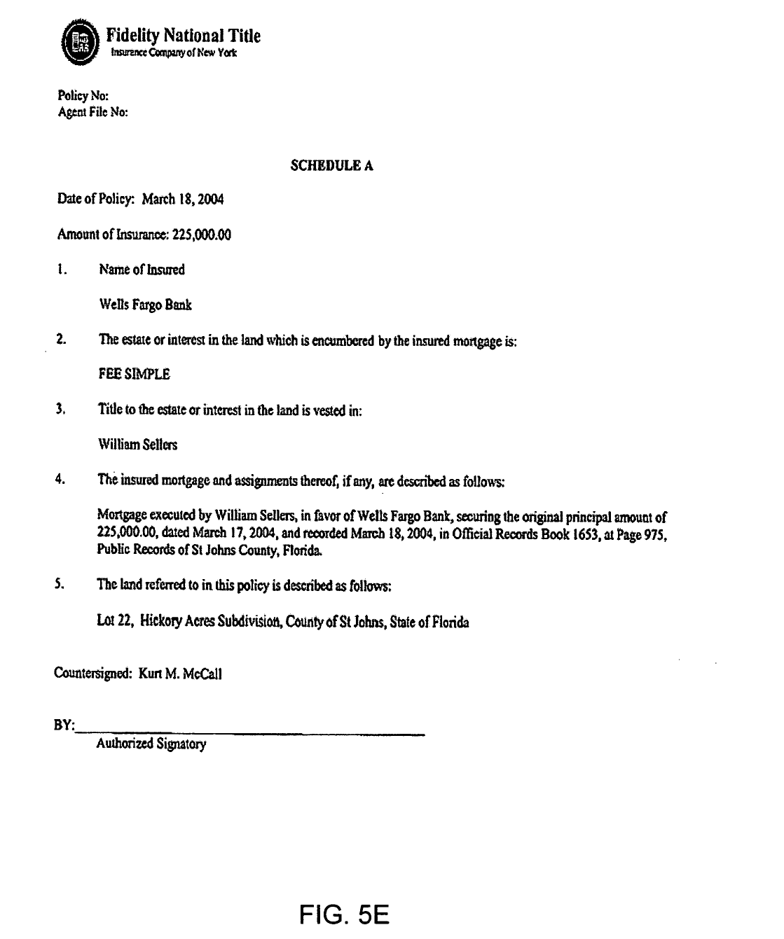

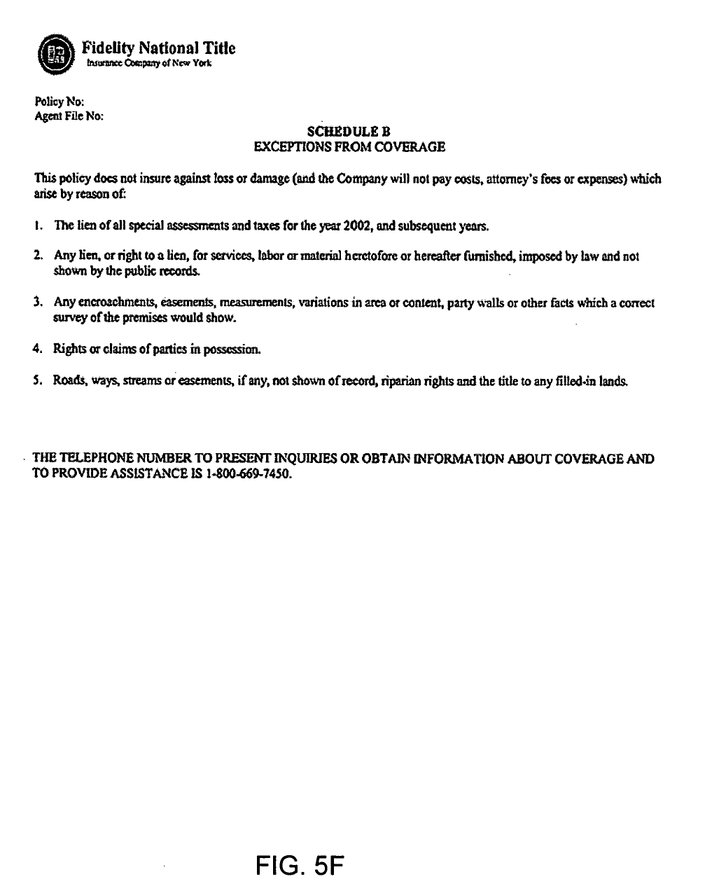

At block 210, a results set is identified that relates to the user's request and the results set is used to produce output at block 212. The existence of a results set relating to the user's request, in some embodiments, facilitates a more rapid response to the request than would otherwise be possible. This typically is the case whether the property records and associated data are electronic documents or physical documents. In some embodiments, the presence of pre-search results sets facilitates a near-real-time response, thus allowing many services requiring property records searches to be accomplished “while-you-wait.” The output may comprise any or all of the items identified in the user's request. The output may be an electronic file sent to the user, a display screen on the user's computer, a fax to the user, a printout mailed to the user, and the like. If the output is electronic, it may include hyperlinks to more detailed information, to document images, and the like. Exemplary output documents are described hereinafter with respect to FIGS. 5A-5F.

Because new property records continue to be generated, the method 200 includes a process for updating results sets when new records are received. This process is represented by blocks 214 and 216. At block 214, additional property records are received and saved. This block essentially mirrors block 202 discussed previously. The new records are added to the existing records.

At block 216, certain results sets are updated. Results sets may be updated in any of a number of ways. For example, the new property records may be searched to identify all parcels to which the new records relate. Then the associated results sets may be updated by conducting a new search on only those parcels. The results would then be saved as an updated results set and may include any of the previously-mentioned items. In other embodiments, new searches may be performed for all parcels in the geographic region. Other examples exist.

Searching property records prior to a specific request also allows anomalies to be identified and corrected. This process is represented by blocks 218 and 220. Anomalies may exist for may reasons: data entry errors, broken chains of title, and the like. The searches performed at blocks 204 and 216 may uncover these anomalies. Thus, at block 218, the results sets are evaluated to identify anomalies. This may result in an anomaly report, simply a notation in the results set, and/or the like. In either case, the errors may be flagged for follow-up, which may take place at block 220. A clerk, administrator, examiner, or the like may review the anomaly report and take any necessary corrective action, such as reviewing the source property record and making any necessary corrections to the stored data, making a judgment about conflicting data and making the appropriate corrections, and/or the like. Many such examples are possible. In some embodiments, the anomaly correction process comprises a guided title examination process such as described more fully in previously-incorporated U.S. patent application Ser. No. 10/966,154, entitled “TITLE EXAMINATION SYSTEMS AND METHODS.” Thus, when a user requests a search that otherwise would have resulted in less than the desirable output due to an anomaly, the user may nevertheless get the desired output since the anomaly may have been corrected.

In some embodiments, the results sets may be used to improve the efficiency of the existing search system or future search systems. The results sets may be used to produce any of a number of usefully reports to this end. The reports may include metrics, data compilations, use statistics, and/or the like. For example, the efficiency of a searchable property records system may be improved by keeping the number of records to a minimum. One way to do this would be to identify a point-in-time after which most parcels have at least one good stop. Records prior to this point-in-time may be kept in a secondary database, while records subsequent to this point-in-time may be kept in a primary database. As long as a search relating to a specific parcel results in a good stop using the primary database, then the records in the secondary database need not be searched in many cases. Using reports such as those described herein may help to identify the point-in-time referred to above. Statistics also may be maintained that track the number of documents a typical search returns and/or the time a typical search takes. This information may be used for future pricing decisions and system configuration.

Thus, at block 222 results sets are analyzed in response to a specific report request. An exemplary report request may include a query to determine the point-in-time referred to immediately above. To wit, what percentage of parcels have at least one good stop subsequent to Jan. 1, 1980? Those skilled in the art will appreciate numerous examples of such reports in light of this disclosure. The report is generated at block 224.

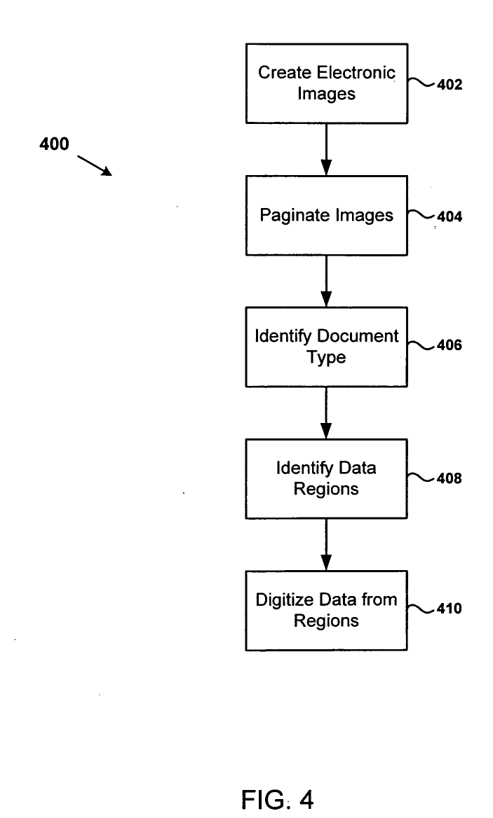

Attention is now directed to FIG. 4, which illustrates an exemplary data input method 400 according to embodiments of the invention. The method 400 may be implemented in the data input system 118 of FIG. 1. This process is described in greater detail in previously incorporated Provisional U.S. Patent Application No. 60/554,511, (Attorney Docket No. 040143-000100). At block 402 electronic images are created of recorded property records. In some embodiments, this is done by the recording entity; in others, this is done by other entities. The process may involve scanning from paper, microfilm, microfiche, and the like.

The process continues at block 404 wherein the electronic images are logically paginated and grouped. Many recorded documents extend over several pages and identifying breaks between documents may be necessary. This process may be accomplished manually or electronically. If accomplished electronically, the input system 118 may be programmed to recognize various indications of a document break. When such a break is encountered, the system inserts an indicator that signals the break for future operations.

At block 406, each group of pages representing a common document is evaluated to identify the document's type. This also may be done electronically or manually. If done electronically, the input system 118 may be programmed to identify document titles or other indicators of a document's type. The input system 118 also may programmed to evaluate the content of a document, using, for example, optical character recognition (OCR), to determine the document type based on the content. Other examples are possible.

At block 408, data regions are identified on the document. This process may be assisted by having previously identified the document type. Certain types of documents have consistent data regions. Often the regions are located at a consistent location on the document. Thus, in some embodiments the process may be automated and may use OCR to evaluate the content of the region to confirm proper identification. Although OCR may be used, it is not necessary at this stage to parse the content. It is sufficient to merely confirm that the content “looks like a legal description,” for example.

Once the data regions are identified, the content of the regions is digitized at block 410. Digitizing the content involves converting the image information to searchable data that may be loaded into a database. In some embodiments, this involves using OCR and translation algorithms to parse the information, evaluate its content, segment it into appropriate data elements, or post documents to a particular geographic location in the database to aid in searching and locating. Translation algorithms may be specifically designed to work with the types of records being operated on. Exemplary translation algorithms are more fully described in previously-incorporated Provisional U.S. Patent Application No. 60/554,514, entitled “CONFIDENCE-BASED NATURAL LANGUAGE PARSING” (Attorney Docket No. 040143-000500), and in Provisional U.S. Patent Application No. 60/554,513, entitled “CONTEXTUAL CONVERSION OF LANGUAGE TO DATA” (Attorney Docket No. 040143-000600). In some embodiments, the digitizing process is performed manually. For example, data entry clerks may view the content of a data region and manually enter the content into an input device. The process may be highly automated. For example, the input system may be programmed to extract data regions from many documents and present them one-at-a-time to a clerk who reads the information and keys it into an input device. Many other examples are possible, including those that use a combination of electronic and manual data entry.

It is to be understood that the data input method 400 is but one example of a process for reducing recorded documents to searchable data. Other such methods may include more, fewer, or different operations. Further, the operations described herein may be performed in different orders than just described. Those skilled in the art will recognize a number of such possibilities in light of this disclosure.

Attention is directed to FIGS. 5A-5F, which illustrate exemplary output documents according to embodiments of the invention. Exemplary electronic output is illustrated in FIGS. 6B, 6C, and 6F. FIG. 5A illustrates a first section of an exemplary title abstract. This exemplary section includes Vesting Deed Information and Legal Description(s) of Subject Property. FIG. 5B illustrates a second exemplary section of a title abstract. In some embodiments, the title abstract includes all data needed by an examiner to underwrite a policy or loan using commonly-accepted underwriting rules. Thus, the examiner need not refer to the source documents to complete the underwriting process.

The abstract may include a list of relevant documents. In some embodiments, this list contains only enough information for a searcher to locate documents manually. The list may include a relevance score, which may be determined in any of a number of ways. For example, documents having an address that correlates perfectly with the parcel may be considered highly relevant, while documents having the same grantee but a different property address may be considered less so. Many other examples exist. A document's relevance may be expressed as a percentage and ranked accordingly on the output document. Those skilled in the art will recognize other possibilities in light of this disclosure.

Additionally, the title abstract may include a score, grade, or exceptions list that provides an indication of the quality of the title as it relates to the marketability of the property it represents. In other words, parcels with “clean” titles will have more favorable scores. The score could be used to approve a loan, commit to a loan, determine settlement fees and/or closing costs associated with closing a loan, and/or the like. A title score may be calculated in any of a number of ways using a variety of factors. For example, factors may include: the number and types of documents relating to the parcel; the presence of judgments, tax liens, lis pendens, and/or the like; chain of title breaks; unusual vesting and/or ownership conditions; insurance claims history; and the like. Each of these factors may include conditions within. For example, with respect to the number and types of documents relating to the parcel, additional considerations may include: unreleased encumbrances; modified or assigned encumbrances; and the like. With respect to judgments, tax liens and lis pendens, consideration may be given to whether these encumbrances are within the statute of limitations for the particular jurisdiction for that type of judgment. Breaks in a chain of title may be reconciled with other documents such as divorce decrees, death certificates, and the like. Many other examples are possible and apparent to those skilled in the art in light of this disclosure.

With respect to calculating the actual score based on the foregoing factors, many possibilities exist. For example, each of the various factors and sub factors may receive a particular weighting, and the presence or absence of particular conditions may be combined with the weighting to determine the final score. As another example, any of a number of conditions may receive a value, and the values for all conditions may be combined to arrive at the score or detract from an ideal score. Many such possibilities exist and are apparent to those skilled in the art in light of this disclosure. In some examples the title score is a title grade, such as a letter grade. In some embodiments, the summary is a list of exceptions such as unreleased liens and mortgages, unresolved judgments, and the like.

FIG. 5C illustrates a first page of a commitment that may be produced according to some embodiments. FIG. 5D illustrates a second page that includes conditions that must be met before a policy will be issued based on the commitment. FIGS. 5C and 5D illustrate a commitment for an owner's policy in the amount of $225,000. Thus, a mortgage company may obtain a title commitment electronically merely by requesting one via the Internet. The title commitment illustrates in FIGS. 5C and D may be automatically produced, in some embodiments, following a process of automated title examination, wherein business rules are used to accomplish the process previously performed manually. Title policies and other such documents may be generated similarly.

FIGS. 5E and 5F illustrate two pages from a policy that may be produced according to some embodiments. These pages represent a lender's policy. FIG. 5E illustrates Schedule A, which includes the basic policy information; FIG. 5F illustrates Schedule B, which includes the Exceptions from Coverage.

Attention is directed to FIGS. 6A-6F, which illustrate a series of display screens that a user may view in the process of interacting with the system described herein. These display screens are merely exemplary, as will be appreciated by those skilled in the art. The display screens may be produced by the network interface 116 of FIG. 1, which may be, for example, a web server. The screens then may be viewed using browser software residing on a user device, such as a personal computer, as is known in the art. FIG. 6A illustrates a request screen through which a user may request a title search. The screen includes data fields for names, address, county and state. A Search by drop down menu may be used to select from a number of different search methods, including: address; legal description; source document; and the like. Some of these fields may be required fields, while others may be optional. The user completes the required fields and any of the optional fields the user desires to complete. The screen also may include fields for requesting the type of output the user desires. For example, the user may desire a document list, a title abstract, a title policy, and/or the like. Additionally, the user may desire to have a relevance associated with each document and may desire a marketability score or grade for a parcel. Once all the fields are complete, the user may submit the request by selecting the search button.

Those skilled in the art will appreciate that other examples according to embodiments of the invention may have the fields on different display screens. Other examples may use more or fewer screens and fields. For example, other display screens may include payment fields, account setup and management fields and the like. Many variations are possible.

FIG. 6B illustrates an exemplary document list display screen that may be returned to the user. This list includes documents identified in the search. The list may be color coded to provide the user with additional information as more fully explained in previously-incorporated U.S. patent application Ser. No. 10/804,467, entitled “DOCUMENT ORGANIZATION AND FORMATTING FOR DISPLAY” (Attorney Docket No. 040143-000400). The list may include a relevance score for each document as previously described. The list may include hyperlinks or buttons for requesting more detailed information about the identified documents, including an image of the document. Many other examples are possible.

FIG. 6C illustrates an exemplary document summary screen according to an embodiment of the invention. The document summary screen includes relevant information from a selected document.

FIGS. 6D and 6E illustrate first and second portions of an options screen that may be used to define the type of output the user desires.

FIG. 6F illustrates a title abstract display screen according to embodiments of the invention. The title abstract may include a marketability score or grade as previously described. Using the abstract, an examiner may underwrite a policy without reference to the source documents from which the abstract was generated.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to real property records searching specifically or property records searching generally. For example, the present invention may be used to search corporate filings, license records, and the like. Accordingly, the above description should not be taken as limiting the scope of the invention, which is defined in the following claims.

1. A property searching method, comprising:
receiving property records relating to a plurality of parcels at a host computer system;
storing the records in a searchable database;
for each of the plurality of parcels, searching the property records to identify property records relating to the parcel, thereby producing a results set for each parcel, wherein the results set for each parcel comprises the property records relating to that parcel;
saving the results set for each of the plurality of parcels;
receiving additional property records at the host computer system, wherein the additional property records relate to only selected ones of the plurality of parcels;
updating the results set for each of the selected ones of the plurality of parcels, thereby creating an updated results set for each of the selected ones of the plurality of parcels;
saving the updated results sets;
at the host computer system, receiving a request from a user for a data summary relating to a specific parcel, wherein the specific parcel is one of the selected ones of the plurality of parcels;
using the updated results set for the specific parcel to prepare the data summary; and
sending the data summary to the user.

2. A method of searching property records relating to a plurality of parcels, the method comprising:
for each parcel in the plurality of parcels:
searching the property records to identify specific documents relating to the parcel, thus creating a results set for the parcel;
organizing the results set; and
saving the results set;
receiving a request from a user for a data summary relating to a specific parcel, wherein the specific parcel has a results set associated therewith;
using the results set to prepare the data summary; and
sending the data summary to the requestor;
wherein searching the property records is performed prior to receiving a request from any requester.

3. The method of claim 2, wherein each results set comprises information from which an underwriter can underwrite a title policy, using commonly-accepted title policy underwriting rules, without reference to source documents, or images thereof, from which the results set originated.

4. The method of claim 2, further comprising:
receiving property record data for a plurality of parcels into a computer system, wherein the property record data relates to source property record documents; and
storing the property record data in a searchable database as the property records.

5. The method of claim 2, wherein the data summary comprises a selection from the group consisting of purchase title policy, refinance title policy, prelim, title information report, abstract, purchase title commitment, refinance title commitment, document, data stream, and electronic transmission.

6. The method of claim 2, wherein the results set comprises a selection from the group consisting of purchase title policy, refinance title policy, prelim, title information report, abstract, purchase title commitment, refinance title commitment, and title score.

7. The method of claim 2, wherein the property records comprise physical documents.

8. The method of claim 2, wherein the property records comprise electronic documents.

9. A method of searching property records relating to a plurality of parcels, comprising:
receiving a plurality of property records at a host computer system;
storing the property records in a searchable database;
for each of the plurality of parcels, searching the database to identify property records relating to the parcel, thereby producing a results set for each parcel, wherein the results set for each parcel comprises the property records relating to that parcel;
saving the results set for each of the plurality of parcels;
for each of the plurality of results sets:
identifying relationships among the property records in the results set;
using the property records and relationships to identify anomalies;
correcting the anomalies; and
updating the results set, thereby creating an updated results set for each parcel having an anomaly;
saving the updated results set;
at the host computer system, receiving a request from a user for a data summary relating to a specific parcel, wherein the specific parcel has an updated results set associated with it;
using the updated results set for the specific parcel to prepare the data summary; and
sending the data summary to the user.

10. A method of searching property records relating to a plurality of parcels, comprising:
receiving a plurality of property records at a host computer system;
storing the property records in a searchable database;
for each of the plurality of parcels, searching the database to identify property records relating to the parcel, thereby producing a results set for each parcel, wherein the results set for each parcel comprises the property records relating to that parcel;
saving the results set for each of the plurality of parcels;
for each of the plurality of results sets, identifying relationships among the property records in the results set;
using the relationships and results sets to generate a report;
using the report to revise the database;
at the host computer system, receiving a request from a user for a data summary relating to a specific parcel;
using the revised database to prepare the data summary; and
sending the data summary to the user.

11. The method of claim 10, wherein the plurality of records comprise a first plurality of records related to a first geographic region and wherein using the report to revise the database comprises selecting records from a second plurality of records relating to a second geographic region to include in the searchable database.

12. The method of claim 11, wherein the first and second geographic regions comprise the same region.

13. The method of claim 11, wherein the first and second geographic regions comprise different regions.

14. The method of claim 10, wherein the report comprises information relating to the number of parcels in the plurality of parcels having a good stop subsequent to a particular date.

15. A property records search system, comprising:
a host computer system;
a searchable database; and
software that programs the host computer system to:
receive property records relating to a plurality of parcels;
store the property records in a searchable database;
for each of the plurality of parcels, search the property records to identify property records relating to the parcel, thereby producing a results set for each parcel, wherein the results set for each parcel comprises the property records relating to that parcel;
save the results set for each of the plurality of parcels;
receive a request from a user for a data summary relating to a specific parcel, wherein the specific parcel has a results set associated therewith;
use the results set to prepare the data summary; and
send the data summary to the requestor.

16. The system of claim 15, wherein the data summary comprises a selection from the group consisting of purchase title policy, refinance title policy, prelim, title information report, abstract, purchase title commitment, refinance title commitment, document, data stream, and electronic transmission.

17. The system of claim 15, wherein the results set comprises a selection from the group consisting of purchase title policy, refinance title policy, prelim, title information report, abstract, purchase title commitment, refinance title commitment, and title score.

18. The system of claim 15, wherein the software further programs the host computer system to:
for each of the plurality of results sets, identify relationships among the property records in the results set;
use the relationships and results sets to generate a report;
use the report to revise the database; and
use the revised database to prepare the data summary.

19. The system of claim 18, wherein the records comprise a first plurality of records related to a first geographic region and wherein in programming the host computer system to use the report to revise the database, the software programs the host computer system to select records from a second plurality of records relating to a second geographic region to include in the searchable database.

20. The system of claim 18, wherein the first and second geographic regions comprise the same region.

21. The system of claim 18, wherein the first and second geographic regions comprise different regions.

22. The system of claim 18, wherein the report comprises information relating to the number of parcels in the plurality of parcels having a good stop subsequent to a particular date.

23. The system of claim 15, wherein the software further programs the host computer system to:
for each of the plurality of results sets:
identify relationships among the property records in the results set;
use the property records and relationships to identify anomalies;
correct the anomalies; and
update the results set, thereby creating an updated results set for each parcel having an anomaly;
save the updated results sets; and
use an updated results set to prepare the data summary.

24. The system of claim 15, wherein the software further programs the host computer system to:
receive additional property records at the host computer system, wherein the additional property records relate to only selected ones of the plurality of parcels;
update the results set for each of the selected ones of the plurality of parcels, thereby creating an updated results set for each of the selected ones of the plurality of parcels;
save the updated results sets; and
use an updated results set to prepare the data summary.

25. Computer-readable media having stored thereon computer-executable instructions for performing a method, comprising:
receiving property records relating to a plurality of parcels;
storing the property records in a searchable database;
for each of the plurality of parcels, searching the property records to identify property records relating to the parcel, thereby producing a results set for each parcel, wherein the results set for each parcel comprises the property records relating to that parcel;
saving the results set for each of the plurality of parcels;
receiving a request from a user for a data summary relating to a specific parcel, wherein the specific parcel has a results set associated therewith;
using the results set to prepare the data summary; and
sending the data summary to the requestor.
